(19) United States
(12) Patent Application Publication
(10) Pub. No.: US 2023/0126908 A1
(43) Pub. Date: Apr. 27, 2023

(54) PROTECTION AGAINST EXECUTING INJECTED MALICIOUS CODE

(71) Applicant: International Business Machines Corporation, Armonk, NY (US)

(72) Inventor: Rajat Rao, Bangalore (IN)

(21) Appl. No.: 17/511,643

(22) Filed: Oct. 27, 2021

(51) Int. Cl. G06F 21/54; G06F 21/60

(52) U.S. Cl. CPC G06F 21/54; G06F 21/602; G06F 2221/2125

(57) ABSTRACT

A computer-implemented method includes receiving, by a processing unit, an input-value of an operand used by a computer-executable instruction. The method further includes generating, by the processing unit, an encrypted-value by encrypting the input-value, and storing the encrypted-value in a memory. In response to a request to execute the computer-executable instruction, the processing unit decodes the computer-executable instruction into a machine-executable code and decrypts the encrypted-value for use by the machine-executable code. Upon executing the machine-executable code, the processing unit generates an encrypted-result by encrypting a result of the execution, stores the encrypted-result in the memory.

### BACKGROUND

The present invention generally relates to computer technology, particularly computer security, and techniques to protect against executing injected malicious code through encryption of program data.

Today, computing devices, such as desktops, laptops, tablet computers, phones, etc., have become ubiquitous. Such computing devices are used for almost everything, such as communication, word processing, banking, e-commerce, e-learning, browsing, entertainment, record keeping, healthcare, and several other fields and applications. As such, computing devices have access to sensitive and private data that users desire to protect and secure. While various computer security measures are available, improvement to computer security is desirable.

### SUMMARY

According to one or more embodiments of the present invention, a computer-implemented method includes receiving, by a processing unit, an input-value of an operand used by a computer-executable instruction. The method further includes generating an encrypted-value by encrypting the input-value by the processing unit and storing the encrypted-value in a memory. In response to a request from the processing unit, to execute the computer-executable instruction, decoding the computer-executable instruction into a machine-executable code, and decrypting the encrypted-value for use by the machine-executable code. Upon executing the machine-executable code, the processing unit generates an encrypted-result by encrypting a result of the execution and stores the encrypted-result in the memory.

According to one or more embodiments of the present invention, a system includes a memory, and one or more processing units coupled with the memory, the one or more processing units are configured to perform a method for protecting against executing injected malicious code. The method includes receiving an input-value of an operand used by a computer-executable instruction. The method further includes generating an encrypted-value by encrypting the input-value, and storing the encrypted-value in a memory. In response to a request to execute the computer-executable instruction, the computer-executable instruction is decoded into a machine-executable code and the encrypted-value is decrypted for use by the machine-executable code. Upon executing the machine-executable code, an encrypted-result is generated by encrypting a result of the execution, and the encrypted-result is stored in the memory.

According to one or more embodiments of the present invention, a computer program product comprising a computer-readable memory that has computer-executable instructions stored thereupon, the computer-executable instructions when executed by a processor cause the processor to perform a method for protecting against executing injected malicious code. The method includes receiving an input-value of an operand used by a computer-executable instruction. The method further includes generating an encrypted-value by encrypting the input-value, and storing the encrypted-value in a memory. In response to a request to execute the computer-executable instruction, the computer-executable instruction is decoded into a machine-executable code and the encrypted-value is decrypted for use by the machine-executable code. Upon executing the machine-executable code, an encrypted-result is generated by encrypting a result of the execution, and the encrypted-result is stored in the memory.

The above-described features can also be provided at least by a system, a computer program product, and a machine, among other types of implementations.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts example malicious code attacks on a computer according to one or more embodiments of the present invention;

FIG. 2 depicts a system according to one or more embodiments of the present invention;

FIG. 3 depicts an example of program data and code according to one or more embodiments of the present invention;

FIG. 4 depicts a flowchart of a method for protection against executing injected malicious code according to one or more embodiments of the present invention;

FIG. 5 depicts an example scenario of preventing malicious code attack according to one or more embodiments of the present invention;

FIG. 6 depicts an example scenario of preventing malicious code attack according to one or more embodiments of the present invention;

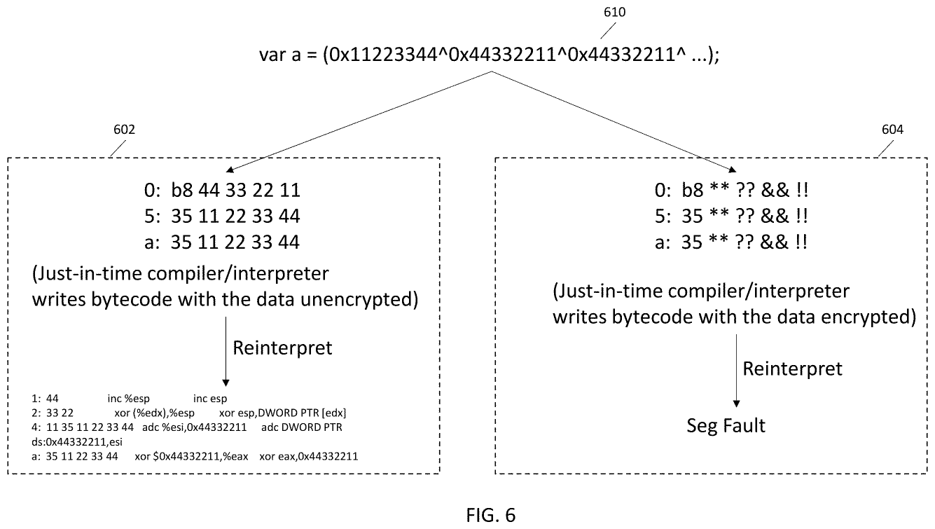

FIG. 7 depicts another example scenario of preventing malicious code attack according to one or more embodiments of the present invention; and

FIG. 8 depicts a computing system according to one or more embodiments of the present invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

In the accompanying figures and following detailed description of the disclosed embodiments, the various elements illustrated in the figures are provided with two or three-digit reference numbers. With minor exceptions, the leftmost digit(s) of each reference number corresponds to the figure in which its element is first illustrated.

### DETAILED DESCRIPTION

Technical solutions are described herein to improve the security of a computer by protecting against executing injected malicious code through encryption of program data. Embodiments of the present invention address the technical challenges of providing computer security. Embodiments of the present invention facilitate preventing the execution of computer programs that have been modified at runtime, potentially maliciously. Embodiments of the present invention are rooted in computing technology. Embodiments of the present invention provide a practical application to the technical challenge of malicious code attacks by protecting against executing injected malicious code through encryption of program data.

Malicious code is harmful computer programming scripts designed to create or exploit vulnerabilities in a computing device. A threat actor prepares malicious code to cause unwanted changes, damage, or ongoing access to computing devices. Malicious code may result in back doors, security breaches, information and data theft, and other potential damages to files and computing devices. In some instances, malicious code can also be used to cause financial harm to a user. Embodiments of the present invention address such technical challenges and facilitate protection against malicious code being successfully executed on a computing device, and in turn, preventing the damage. Herein, a computing device is also referred to as a computer. A computer can be any type of electronic device with one or more processing units, for example, a desktop computer, a laptop computer, a tablet computer, a phone, a wearable, a smart lock, a vehicle infotainment system, or any other type of electronic device.

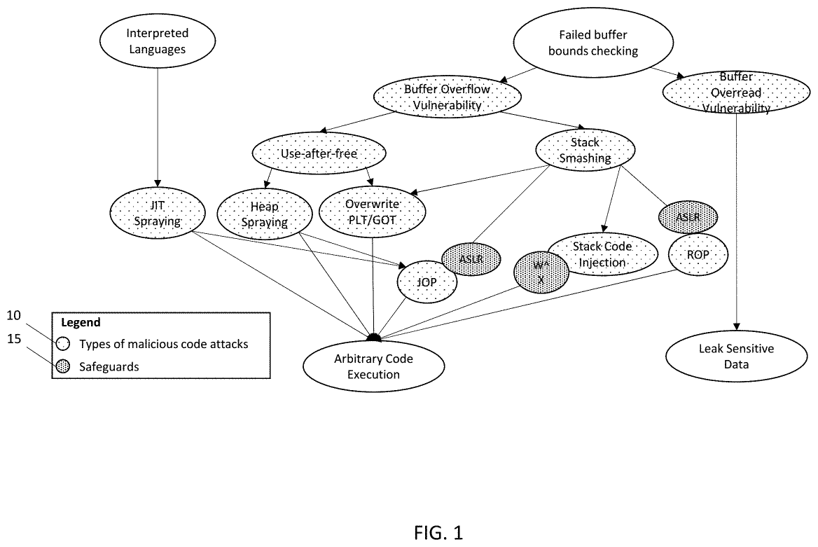

FIG. 1 depicts examples of malicious code attacks on a computer according to one or more embodiments of the present invention. As can be seen, a computer is susceptible to being attacked by malicious code in several different ways (10). For example, a known malicious code attack is “buffer overflow attack.” To exploit a buffer overflow, an attacker sends a message containing malicious code to a computer. The message includes code (i.e., computer-executable instructions) that overrides an address pointer (i.e., reference to a memory location) with an address (i.e., memory location) of the interjected malicious code. In due course, the overwritten pointer is copied into the program counter of the computer's processing unit (i.e., processor). The processing unit then executes the malicious code. Such buffer overflow attacks, and other malicious code attacks, create a way for an attacker to obtain sensitive information from the computer, destabilize the computer, and/or open the computer to use as a source node in a distributed denial of service (DoS) attack. Buffer overflow attacks are common, easy to exploit, hard to eliminate, and potentially highly damaging when successful.

In the case of a buffer overflow attack, what is exploited is that a buffer of data in a program is meant to have certain bounds based on a size of the buffer. A “buffer” represents a portion of the memory of the computer, typically contiguous memory locations, that are allocated to store program data that is used during the execution of the program. Here, “program” is a computer program, i.e., software, that is being executed on the computer. “Program data” includes variables or other types of intermediate data that are used during the execution of the program. In some types of programs, for example, those that are not written using just-in-time compilation programming languages, the buffer overflow attack is more typical. Typically, in such a program, if the bounds of an allocated buffer are violated (no checking), it is possible to read/write sections of memory outside the buffer. A buffer overflow vulnerability allows the injection of malicious code by an attacker. A buffer overread vulnerability allows an attacker to read arbitrary amounts of memory, potentially leaking sensitive data.

As shown in FIG. 1, several types of malicious code attacks (10) are known. “Gadgets” that perform specific functions can be found and exploited with return-oriented programming (ROP) attacks. Alternatively, the attacker can subvert the program's execution by corrupting the procedure linkage table (PLT) and/or global offset table (GOT). “Heap spraying” is another type of malicious code attack (10) that gets the program to allocate a buffer in memory and spray the buffer with computer-executable instructions. This allows the attacker to construct gadgets in the heap of the process (i.e., executing instance of the program), followed by a jump-oriented programming (JOP) attack. It is understood that the types of malicious code attacks (10) shown in FIG. 1 are exemplary and that several other types of malicious code attacks (10) exist or can be developed. Embodiments of the present invention are applicable to any such types of malicious code attacks (10) and not limited to those in FIG. 1 or described herein.

Several existing malicious code prevention techniques (15) have been developed to address the technical challenge of such malicious code attacks. For example, memory, where the code of the program is stored, can be marked as RX (read, execute) only, whereas data memory, where the program data is stored, is marked RW (read, write) only. So, memory is either W or X, potentially preventing injecting code through buffer overflow from being executed.

In another existing technique (15), a stack canary is used to detect modifications of the stack. If the attacker modifies the stack to return to some malicious code, the canary gets corrupted, and the program detects stack smashing. In yet another existing technique (15), system libraries (e.g., libc libraries) have enough ROP gadgets to be Turing complete. But the attacker needs to know the address of these gadgets to exploit a malicious code attack. To prevent the attacker knowing the address, address space layout randomization (ASLR) is used to randomize the address space of the libraries. If the executable was compiled to be a position-independent executable (PIE), then the different segments of the process are also position-independent.

However, as can be seen in FIG. 1, the existing malicious code prevention techniques (15) are not able to prevent all types of malicious code attacks (10). Further, the malicious code prevention techniques (15) themselves require computing resources as an overhead to execute the program, which can cause the program to slow down. Particularly, with different types of malicious code prevention techniques (15) deployed the execution of the program can be slowed substantially.

Embodiments of the present invention address the technical challenge of a computer being attacked using malicious code. Embodiments of the present invention facilitate preventing the successful execution of several types of malicious code attacks. Further, embodiments of the present invention also address technical challenges associated with the existing malicious code prevention techniques (15). Advantages of the technical solutions provided by one or more embodiments of the present invention will be apparent from the description herein to a person skilled in the art.

Embodiments of the present invention facilitate encrypting any type of program data in the computer, except when the program data is in an “execute” stage of an instruction execution pipeline of the processing unit. Hence, any injected code (that is injected as program data) is in an encrypted state and cannot be handled correctly by a “decode” stage of the instruction execution pipeline. In this manner, one or more embodiments of the present invention facilitate that the code pages (program and libraries) are the only ones that can now be successfully executed. Any “program data” that includes code (i.e., malicious code) cannot be decrypted correctly, and hence, cannot be executed by the computer.

In this manner, one or more embodiments of the present invention prevent exploiting vulnerabilities in a compiled program. Additionally, one or more embodiments of the present invention also prevent interpreters from being maliciously attacked. JIT spraying cannot be done with a computer that is using one or more embodiments of the present invention because any code that the JIT compiler generates will have the program data (or the attacker's malicious payload) encrypted. The attacker cannot use it to execute instructions. Similarly, any variable data (i.e., program data) in JavaScript is encrypted using one or more embodiments of the present invention, which results in the malicious code being invalid machine instructions at the time of execution in the processor's instruction execution pipeline.

Further, embodiments of the present invention facilitate, unlike software-based techniques (15), preventing buffer over-reads. As described herein, in one or more embodiments of the present invention, each executing process has a different encryption key. A buffer over-read in one process will not leak sensitive data from another process.

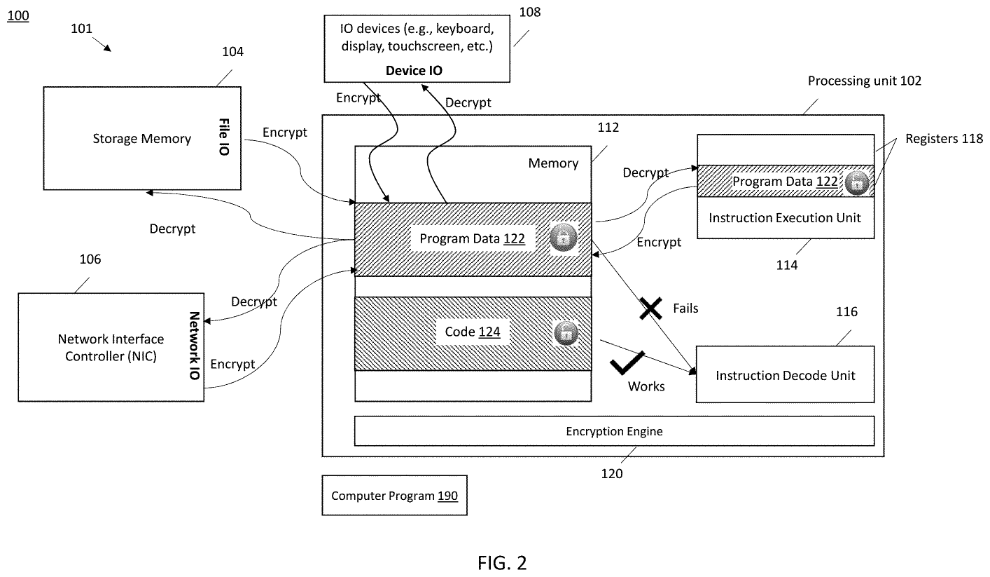

FIG. 2 depicts a system 100 according to one or more embodiments of the present invention. System 100 includes a computing device 101 that is executing a computer program 190. The computer program 190 can be a software, library, add-in, plugin, driver, or any other computer program product executable by the computing device 101. The computing device 101 executes the computer program 190 using a processing unit 102, among other components. The processing unit 102 can include, among other components, a memory 112, an instruction execution unit 114, an instruction decode unit 116, and registers 118. It is understood that processing unit 102 can include additional components that are not shown, such as arithmetic logic unit, memory controller, clock, etc.

At the time of execution, the computer program 190 is loaded into memory 112. The computer program 190 in memory 112 is divided into program data 122 and code 124. Code 124 includes one or more computer-executable instructions that are part of the computer program 190, and program data 122 includes any intermediate data used by code 124. For example, the program data 122 can include variable data, pointer contents, etc. In one or more embodiments of the present invention, the program data 122 can be a variable allocated by the code 124. A value is provided/updated by a user.

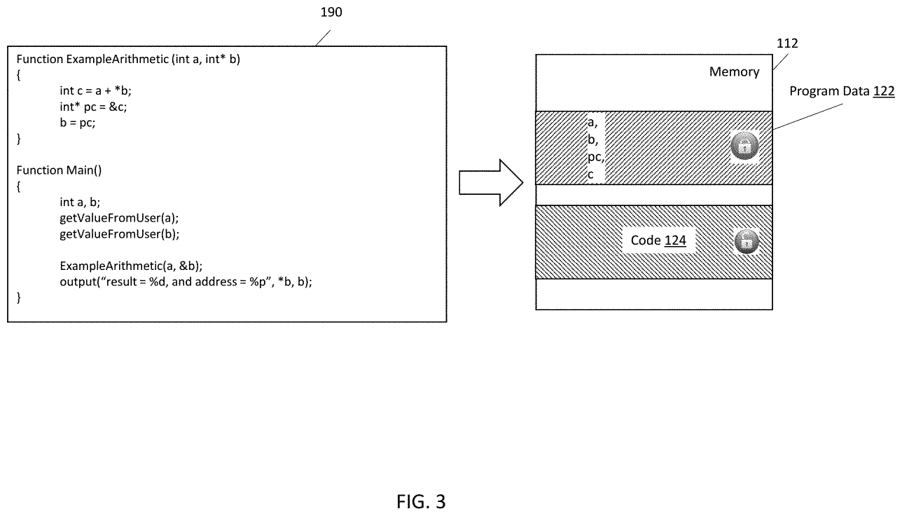

FIG. 3 depicts an example of program data and code according to one or more embodiments of the present invention. It is understood that the computer program 190 that is shown is an example and that in other embodiments of the present invention, the computer program 190 can be different. The computer program 190 can include hundreds, thousands, and even more lines. The program data 122 from the computer program 190 are shown to be stored separately from code 124. In one or more embodiments of the present invention, the code 124 that is stored in the memory 112 can be machine code (i.e., opcodes) rather than high-level computer-executable code (e.g., C/C++, JavaScript, etc.). An “opcode” (or an operation code) can also be referred to sometimes as an instruction machine code, instruction code, instruction syllable, instruction parcel, opstring, etc. In computing, an “opcode” is the portion of a machine language instruction that specifies the processing unit 102 the operation to be performed. Besides the opcode itself, computer-executable instructions also specify operands that the opcode will process, in the form of the program data 122.

Referring again to FIG. 2, the program data 122 can be provided via one or more input/output (I/O) sources. For example, the I/O sources can be a storage memory 104, a network interface controller 106, I/O devices 108 (e.g., keyboard, mouse, touchscreen, etc.), or any other types of I/O sources.

At the time of execution, the instruction decode unit decodes the code 124 and loads the decoded machine-executable instruction in instruction execution unit 114. The instruction execution unit 114 accesses the program data 122 that the decoded instructions include/refer to. The instruction execution unit 114 may access the program data 122 from memory 112, or load the program data 122 into one or more registers 118.

The processing unit 102, according to one or more embodiments of the present invention, includes an encryption engine 120. The encryption engine 120 is responsible for protecting the program data 122. The encryption engine 120 performs an encryption operation of the program data 122 under the conditions, such as at compile time (in case of just-in-time compilation/interpretation) or when the computer program 190 is loaded in the memory 112 for execution. The encryption engine 120 is provided the program data 122, which may include any variable data, pointer contents, etc., that are to be encrypted in this manner. In one or more embodiments of the present invention, the encryption engine identifies the program data 122 itself. The program data 122 can be identified from the metadata, for example, header information, of the computer program 190 in some cases. Depending on the programming language, compiler, linker, and any other tools being used, identifying the program data 122 can vary. Any of the techniques known today, or which will be developed in the future, can be used for identifying the program data 122 in the computer program 190.

Further, in one or more embodiments of the present invention, the encryption engine 120 encrypts the contents whenever a read operation is called on any file, I/O device, or any other I/O source when executing the computer program 190. The encryption engine 120 also encrypts contents that are output by the instruction execution unit(s) 114 to be written into the memory 112 as part of the program data 122.

In one or more embodiments of the present invention, the encryption engine 120 is also responsible for decrypting the encrypted program data 122. It should be noted that in some embodiments of the present invention, the encryption and decryption may be performed by separate components, which together may be referred to as the encryption engine 120.

A decrypt operation is performed when the program data 122 is being loaded into the instruction execution unit 114. Decryption is also performed whenever a write operation is called to output contents of the program data 122 via one or more of the I/O sources.

In one or more embodiments of the present invention, the encryption engine 120 is a hardware unit, such as an application specific integrated circuit (ASIC) that is coupled with the processing unit 102. Alternatively, or in addition, the encryption engine 120 includes one or more hardware components that are part of the processing unit 102. In yet other embodiments of the present invention, the encryption engine 120 can be a combination of hardware and software. In some embodiments of the present invention, the encryption engine 120 includes computer-executable instructions that are executed by the processing unit 102.

The encryption engine 120 can use any known technique to perform encryption/decryption like secure software, dedicated hardware like software guard extension (SGX), a hardware security module (HSM), etc.

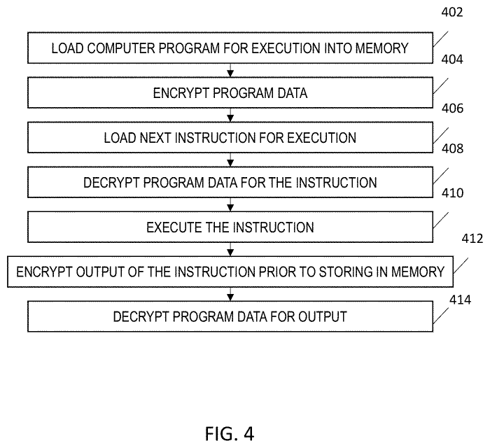

FIG. 4 depicts a flowchart of a method for protection against executing injected malicious code according to one or more embodiments of the present invention. Method 400 includes loading the computer program 190 into memory 112 for execution, at 402. The memory 112 can be cache memory, a random access memory, or any other such memory used during the execution of the computer program 190.

Loading the computer program 190 includes allocating and storing the code 124 and the program data 122 of the computer program separately in the memory 112. The program code 122 for the computer program 190 is identified based on header information included in the computer program by a compiler, a linker, an interpreter, or any other computer programming tool that converts high-level programming language machine-executable code. Alternatively, or in addition, the program code can be identified based on the use of operands versus opcodes in the machine-executable code. In the case where the computer program 190 uses an interpreter, such as a just-in-time interpreter, during execution, there may not be a header created, rather the interpreter translates each line of high-level code in the computer program 190 into a combination of operands and opcodes at runtime. In such a case, the operands are the program data 124, and the opcodes are the code 122.

At block 404, the program data 122 in memory 112 is encrypted by the encryption engine 120. The encryption can be performed using an encryption key in one or more embodiments of the present invention. The encryption engine 120 maintains a separate encryption key for each computer program 190 in some embodiments of the present invention. In some embodiments, the encryption key for a computer program is based on a unique identifier associated with the computer program. For example, a process-identifier, a license-key, or any other such identifier associated with the computer program 190 can be used as the encryption key or generate the encryption key. In some embodiments of the present invention, the encryption key is generated every time the computer program 190 is loaded into the memory 112. Accordingly, separate instances of the computer program 190 will also have separate unique encryption keys. In one or more embodiments of the present invention, the encryption keys are private and not shared (without requisite authorization).

One or more values in the program data 122 are received from one or more I/O sources during the execution of the computer program 190. The user may provide such values via a user interface, for example, using text-boxes, drop-down boxes, etc. Alternatively, or in addition, the value can be received from data stored in the storage memory 104, for example, in files, databases, etc. In one or more embodiments of the present invention, the values can be received over a communication network via the MC 106. Regardless of the source, the received values in the program data 122 are encrypted and stored in memory 112.

The code 124 is not encrypted.

At block 406, the instruction execution unit 114 requests fetching the next instruction as per a stack pointer. The stack pointer points to the memory address of the next instruction in code 124 that is to be executed. In response, the instruction decode unit 116 fetches the content of the memory address (stack pointer) and loads into the instruction execution unit 114, the machine-executable code corresponding to the contents. The instruction decode unit 116 transforms the code 124, i.e., the contents of the memory address, into machine-executable format (e.g., sequence of bits) that the instruction execution unit 114 can process.

At block 408, the encryption engine 120 decrypts the values from the program data 122 that are to be used by the instruction execution unit 114 to execute the loaded instruction. The decrypted content is loaded into the registers 118 in some embodiments of the present invention. Alternatively, or in addition, the decrypted content is made available to the instruction execution unit 114 in memory 112 itself.

The instruction is executed at block 410. At block 412, a result from the instruction execution that is to be output, either for storage into memory 112 or any of the I/O sources, is encrypted by the encryption engine 120. The output is stored in the encrypted program data 122 in memory 112. At block 414, the output value is decrypted and communicated via one or more I/O sources (e.g., storage 104, NIC 106, etc.).

Embodiments of the present invention facilitate conditional encryption or ciphering of memory (cache) contents, the conditional ciphering only the program's data content and not the code section. Any input given to the program—file input, user input, network input, etc. can contain data and cannot contain any code. Such data is stored in an encrypted form in the memory. The output of any operation in the system CPU results in data (or pointers) and cannot contain any code. The output is also encrypted and stored in the memory. Any output from the program—file output, console output, network output, etc. is sent out after decryption of the contents.

Further, in embodiments of the present invention, an instruction fetch request results in decrypted data. The instruction decode stage has access to two types of memory—encrypted data and unencrypted code. One or more code blocks that are read during the decode stage are processed as usual—transformed into machine-executable code and loaded into an execution unit. However, if encrypted data enters the decode stage, an execution fault will result because the encrypted content would not form a valid machine instruction. Hence, an attacker who does not have knowledge of the data ciphering key cannot inject malicious code that will be decoded correctly. Accordingly, embodiments of the present invention prevent malicious code attacks that rely on execution of injected code including, heap spraying followed by subverting the program execution; just-in-time (JIT) spraying followed by subverting the program execution; JOP where the jumps are into injected code; stack code injection; etc.

Additionally, embodiments of the present invention facilitate the protection of buffer overreads against leaking sensitive data belonging to a different process. If each process running in the system has a signature (like process ID) that is used to generate the data cipher key, even if data is read out from a different process, it cannot be decrypted correctly.

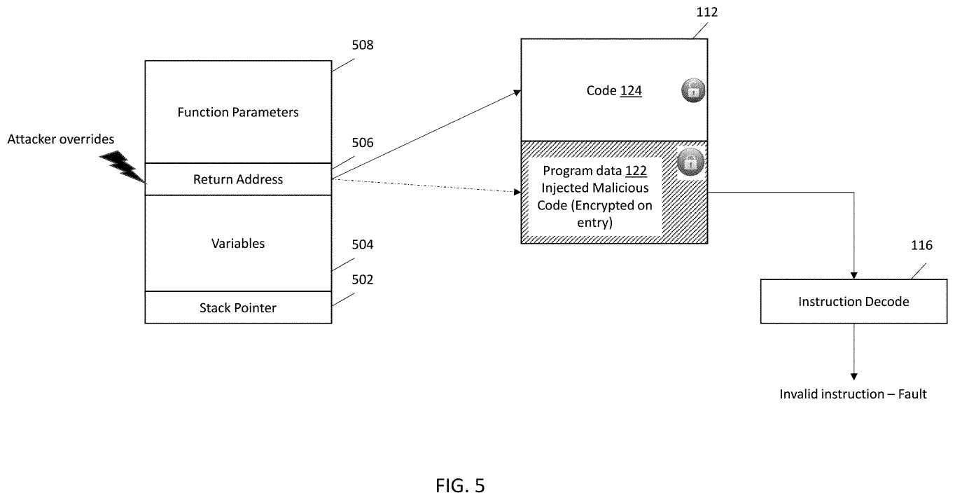

FIG. 5 depicts an example scenario of preventing a malicious code attack according to one or more embodiments of the present invention. Consider that a buffer overflow/overread vulnerability exists in the computer program 190 that is loaded in memory 112. An attacker might be able to gain access to this vulnerability and inject malicious code. For example, consider that the attacker has access to one or more I/O sources. The attacker can craft a message/file for the computer to process as a value of a variable 504 of the program 190. Further, the attacker changes the instruction execution pointer 502 by altering a return address 506 to cause the code in the variable 504 to be executed by the processor 102. Execution of the malicious code can result in the program 190, and in turn the computing device 101 getting compromised.

The function parameters 508 are any parameters passed to a function. In the example of FIG. 3, a is a parameter that is passed to the function ExampleArithmetic. Typically, a programming stack has the parameter values pushed during execution, followed by the return address and finally, the local variables in the function. In the case of embodiments of the present invention, because the program data 124 is encrypted, the contents of the stack are encrypted when the stack is populated. The local variables (e.g., c in FIG. 3) of the function and the function parameters (e.g., a) are program data 124, and accordingly, are encrypted. The function parameters to be encrypted in this manner can be identified during execution as they are pushed to the stack.

Embodiments of the present invention prevent execution of the malicious code in such scenarios, which are sometimes referred to as stack code injection attacks. The attacker is assumed not to have access to the encryption engine 120. In one or more embodiments of the present invention, the malicious code that the attacker injected as part of the variable 504 is encrypted prior to storing in the program data 122. Hence, when the attacker changes the stack pointer 502 from code 124 to the location of the malicious code in the program data 122, the instruction decode unit 116 is unable to decode the content of the stack pointer because of the encrypted contents. Therefore, the transformation of the encrypted content by the instruction decode unit 116 results in an invalid machine-executable code being loaded into the instruction execution unit 114. Thus, an invalid instruction fault (or any other such fault) results, thus, preventing the malicious code from being executed.

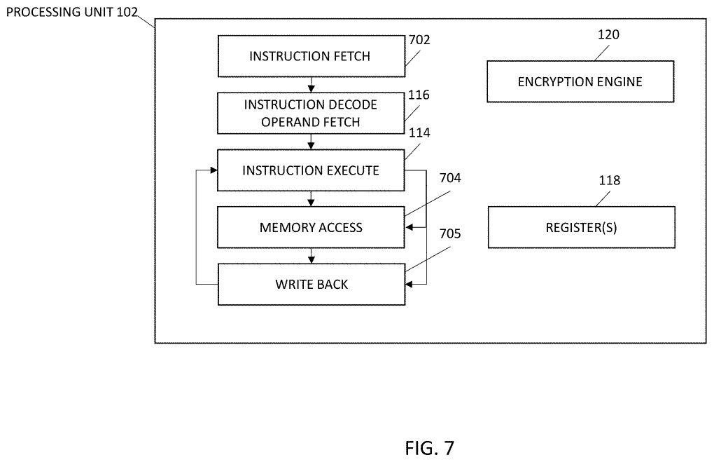

FIG. 7 depicts another example scenario of preventing malicious code attacks according to one or more embodiments of the present invention. The scenario depicted here is for a computer program 190 that is developed and executed for a just-in-time (JIT) interpreter, e.g., .NET-based languages, JVM-based languages, etc. In the depicted scenario, an attacker assigns, as a value to a variable ‘a’ of the computer program 190, a malicious script 610 (i.e., a malicious code).

View 602 depicts a typical execution without the encryption provided by one or more embodiments of the present invention. Here, the malicious script 610 is reinterpreted by the JIT interpreter and executed as part of code 124, resulting in a compromised situation. One or more embodiments of the present invention prevent such a compromise, as shown in view 604. Here, the JIT compiler/interpreter writes the bytecode in the malicious script 610 in an encrypted manner. Hence, the instruction decode unit 116 cannot transform the encrypted malicious script 610 into corresponding machine code that is executable by the instruction execution unit 114. Accordingly, an execution failure results, thus preventing the malicious script 610 from being executed.

Embodiments of the present invention facilitate encrypting all the variable data, pointer addresses, and buffers in memory. Such program data is decrypted only when it is to be processed. In this way, any malicious code that enters the computing device 101 from an attacker is always encrypted. If such encrypted data is forced into the instruction decode unit, it results in a fault, thus preventing the malicious code from executing.

FIG. 7 depicts a block diagram of a processing unit according to one or more embodiments of the present invention. The processing unit 102 can include, among other components, an instruction fetch unit 701, an instruction decode operand fetch unit 116, an instruction execution unit 114, a memory access unit 704, a write-back unit 705, and a set of registers 118. The processing unit 102, in one or more embodiments of the present invention, also includes an encryption engine 120, which can be a hardware security module or any other encryption module.

In one or more embodiments of the present invention, the processing unit 102 can be one of several computer processors in a processing unit, such as a central processing unit (CPU), a graphics processing unit (GPU), a tensor processing unit (TPU), or any other processing unit of a computer system. Alternatively, or in addition, the processing unit 102 can be a computing core that is part of one or more processing units.

The instruction fetch unit 701 is responsible for organizing program instructions to be fetched from memory and executed in an appropriate order and forwarding them to the instruction execution unit 114. The instruction decode operand fetch unit 116 facilitates parsing the instruction and operands, e.g., address resolution, pre-fetching, etc., before forwarding instruction to the instruction execution unit 114. The instruction execution unit 114 performs the operations and calculations as per the instruction. The memory access unit 704 facilitates accessing specific locations in a memory device that is coupled with the processing unit 102. The memory device can be cache memory, volatile memory, non-volatile memory, etc. The write-back unit 705 facilitates recording contents of the registers 118 to one or more locations in the memory device.

It should be noted that the components of the processing unit can vary in one or more embodiments of the present invention without affecting the features of the technical solutions described herein. In some embodiments of the present invention, the components of the processing unit 102 can be combined, separated, or different from those described herein.

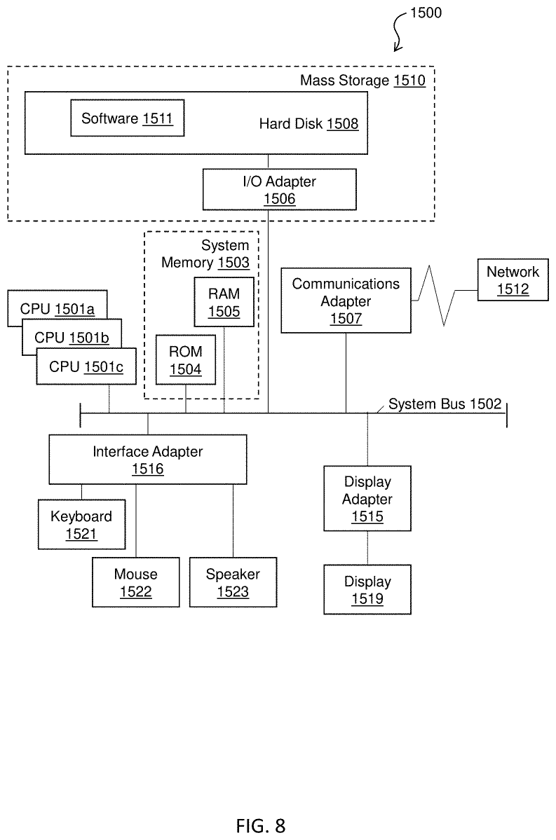

Turning now to FIG. 8, a computer system 1500 is generally shown in accordance with an embodiment. The computer system 1500 can be a target computing system being used to perform one or more functions that require a masked shift add operation to be performed. The computer system 1500 can be an electronic, computer framework comprising and/or employing any number and combination of computing devices and networks utilizing various communication technologies, as described herein. The computer system 1500 can be easily scalable, extensible, and modular, with the ability to change to different services or reconfigure some features independently of others. The computer system 1500 may be, for example, a server, desktop computer, laptop computer, tablet computer, or smartphone. In some examples, computer system 1500 may be a cloud computing node. Computer system 1500 may be described in the general context of computer system executable instructions, such as program modules, being executed by a computer system. Generally, program modules may include routines, programs, objects, components, logic, data structures, and so on that perform particular tasks or implement particular abstract data types. Computer system 1500 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, the computer system 1500 has one or more central processing units (CPU(s)) 1501a, 1501b, 1501c, etc. (collectively or generically referred to as processor(s) 1501). The processors 1501 can be a single-core processor, multi-core processor, computing cluster, or any number of other configurations. The processors 1501, also referred to as processing circuits, are coupled via a system bus 1502 to a system memory 1503 and various other components. The system memory 1503 can include a read only memory (ROM) 1504 and a random access memory (RAM) 1505. The ROM 1504 is coupled to the system bus 1502 and may include a basic input/output system (BIOS), which controls certain basic functions of the computer system 1500. The RAM is read-write memory coupled to the system bus 1502 for use by the processors 1501. The system memory 1503 provides temporary memory space for operations of said instructions during operation. The system memory 1503 can include random access memory (RAM), read only memory, flash memory, or any other suitable memory systems.

The computer system 1500 comprises an input/output (I/O) adapter 1506 and a communications adapter 1507 coupled to the system bus 1502. The I/O adapter 1506 may be a small computer system interface (SCSI) adapter that communicates with a hard disk 1508 and/or any other similar component. The I/O adapter 1506 and the hard disk 1508 are collectively referred to herein as a mass storage 1510.

Software 1511 for execution on the computer system 1500 may be stored in the mass storage 1510. The mass storage 1510 is an example of a tangible storage medium readable by the processors 1501, where the software 1511 is stored as instructions for execution by the processors 1501 to cause the computer system 1500 to operate, such as is described herein below with respect to the various Figures. Examples of computer program product and the execution of such instruction is discussed herein in more detail. The communications adapter 1507 interconnects the system bus 1502 with a network 1512, which may be an outside network, enabling the computer system 1500 to communicate with other such systems. In one embodiment, a portion of the system memory 1503 and the mass storage 1510 collectively store an operating system, which may be any appropriate operating system, such as the z/OS or AIX operating system from IBM Corporation, to coordinate the functions of the various components shown in FIG. 8.

Additional input/output devices are shown as connected to the system bus 1502 via a display adapter 1515 and an interface adapter 1516 and. In one embodiment, the adapters 1506, 1507, 1515, and 1516 may be connected to one or more I/O buses that are connected to the system bus 1502 via an intermediate bus bridge (not shown). A display 1519 (e.g., a screen or a display monitor) is connected to the system bus 1502 by a display adapter 1515, which may include a graphics controller to improve the performance of graphics intensive applications and a video controller. A keyboard 1521, a mouse 1522, a speaker 1523, etc. can be interconnected to the system bus 1502 via the interface adapter 1516, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 8, the computer system 1500 includes processing capability in the form of the processors 1501, and, storage capability including the system memory 1503 and the mass storage 1510, input means such as the keyboard 1521 and the mouse 1522, and output capability including the speaker 1523 and the display 1519.

In some embodiments, the communications adapter 1507 can transmit data using any suitable interface or protocol, such as the internet small computer system interface, among others. The network 1512 may be a cellular network, a radio network, a wide area network (WAN), a local area network (LAN), or the Internet, among others. An external computing device may connect to the computer system 1500 through the network 1512. In some examples, an external computing device may be an external webserver or a cloud computing node.

It is to be understood that the block diagram of FIG. 8 is not intended to indicate that the computer system 1500 is to include all of the components shown in FIG. 8. Rather, the computer system 1500 can include any appropriate fewer or additional components not illustrated in FIG. 8 (e.g., additional memory components, embedded controllers, modules, additional network interfaces, etc.). Further, the embodiments described herein with respect to computer system 1500 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source-code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving, by a processing unit, an input-value of an operand used by a computer-executable instruction;
generating, by the processing unit, an encrypted-value by encrypting the input-value;
storing, by the processing unit, the encrypted-value in a memory;
in response to a request, from the processing unit, to execute the computer-executable instruction:
decoding the computer-executable instruction into a machine-executable code; and
decrypting the encrypted-value for use by the machine-executable code;
executing, by the processing unit, the machine-executable code;
generating, by the processing unit, an encrypted-result by encrypting a result of the execution; and
storing, by the processing unit, the encrypted-result in the memory.

2. The computer-implemented method of claim 1, wherein the computer-executable instruction is stored in the memory in an unencrypted form, separate from a memory buffer allocated to the operand, and contents of the memory buffer being encrypted.

3. The computer-implemented method of claim 1, further comprising identifying the operand during loading, into the memory, a computer program that comprises the computer-executable instruction.

4. The computer-implemented method of claim 3, wherein the operand is identified based on metadata of the computer program.

5. The computer-implemented method of claim 1, wherein the encryption is performed using an encryption key specific to a computer program that comprises the computer-executable instruction.

6. The computer-implemented method of claim 1, wherein the encryption is performed using a hardware module.

7. The computer-implemented method of claim 1, wherein the input-value is assigned to the operand via an input-output source.

8. A system comprising:
a memory; and
one or more processing units coupled with the memory, the one or more processing units are configured to perform a method for protecting against executing injected malicious code, wherein performing the method comprises:
receiving an input-value of an operand used by a computer-executable instruction;
generating an encrypted-value by encrypting the input-value;
storing the encrypted-value in the memory;
in response to a request to execute the computer-executable instruction:
decoding the computer-executable instruction into a machine-executable code; and
decrypting the encrypted-value for use by the machine-executable code;
executing the machine-executable code;
generating an encrypted-result by encrypting a result of the execution; and
storing the encrypted-result in the memory.

9. The system of claim 8, wherein the computer-executable instruction is stored in the memory in an unencrypted form, separate from a memory buffer allocated to the operand, contents of the memory buffer being encrypted.

10. The system of claim 8, wherein the operand is identified during loading, into the memory, a computer program that comprises the computer-executable instruction.

11. The system of claim 10, wherein the operand is identified based on metadata of the computer program.

12. The system of claim 8, wherein the encryption is performed using an encryption key specific to a computer program that comprises the computer-executable instruction.

13. The system of claim 8, wherein the encryption is performed using a hardware module.

14. The system of claim 8, wherein the input-value is assigned to the operand via an input-output source.

15. A computer program product comprising a computer-readable memory that has computer-executable instructions stored thereupon, the computer-executable instructions when executed by a processor cause the processor to perform a method for protecting against executing injected malicious code, wherein performing the method comprises:
receiving an input-value of an operand used by a computer-executable instruction;
generating an encrypted-value by encrypting the input-value;
storing the encrypted-value in a memory;
in response to a request to execute the computer-executable instruction:
decoding the computer-executable instruction into a machine-executable code; and
decrypting the encrypted-value for use by the machine-executable code;
executing the machine-executable code;
generating an encrypted-result by encrypting a result of the execution; and
storing the encrypted-result in the memory.

16. The computer program product of claim 15, wherein the computer-executable instruction is stored in the memory in an unencrypted form, separate from a memory buffer allocated to the operand, contents of the memory buffer being encrypted.

17. The computer program product of claim 15, wherein the operand is identified during loading, into the memory, a computer program that comprises the computer-executable instruction, and wherein the operand is identified based on metadata of the computer program.

18. The computer program product of claim 15, wherein the encryption is performed using an encryption key specific to a computer program that comprises the computer-executable instruction.

19. The computer program product of claim 15, wherein the encryption is performed using a hardware module.

20. The computer program product of claim 15, wherein the input-value is assigned to the operand via an input-output source.
